(19) United States
(12) Patent Application Publication
(10) Pub. No.: US 2012/0047016 A1
(43) Pub. Date: Feb. 23, 2012

(54) USER CONTROL BASED ADVERTISING SYSTEM AND METHOD THEREOF

(75) Inventors: Suk Ku Yu, Seongnam-si (KR); Su-Mi Lee, Seongnam-si (KR); Kyung-Eun Lee, Seongnam-si (KR); Jin A Jung, Seongnam-si (KR); Eun Jung Kim, Seongnam-si (KR); Young Hoon Jung, Seongnam-si (KR); Ellen Jang, Seongnam-si (KR); Jae Young Chang, Seongnam-si (KR); Youngbin Noh, Seongnam-si (KR); Hye Jin Oh, Seongnam-si (KR); Hyung Suk Kim, Seongnam-si (KR)

(73) Assignee: NHN BUSINESS PLATFORM CORPORATION, Seongnam-si (KR)

(21) Appl. No.: 13/203,600

(22) PCT Filed: Feb. 26, 2010
(86) PCT No.: PCT/KR2010/001266

§ 371 Date: Nov. 8, 2011

(30) Foreign Application Priority Data
Feb. 26, 2009 (KR) 10-2009-0016235
Nov. 17, 2009 (KR) 10-2009-0111150

(51) Int. Cl. G06Q 30/02

(52) U.S. Cl. 705/14.54

(57) ABSTRACT

Disclosed are a user control-based advertising system and a method thereof. The user control-based advertising system provides an advertisement display region and an advertisement control region by discriminating the two regions from each other, and comprises: an advertisement region setup unit that sets up the advertisement display region for selectively displaying plural advertisements and the advertisement control region for controlling advertisements displayed therein by discriminating advertisement display and control regions from each other; a communication unit that receives a user command through the advertisement control region and communicates with the advertisement display region according to the received command; and an advertisement control unit that controls the animation function of the advertisement displayed in the advertisement display region according to the user command or controls the movement and selection of other advertisements displayed in the advertisement display region.

### CROSS REFERENCE TO RELATED APPLICATIONS

This application is the National Stage Entry of International Application: PCT/KR2010/001266, filed on Feb. 26, 2010, and claims priority from and the benefit of Korean Patent Application No. 10-2009-0016235, filed on Feb. 26, 2009 and Korean Patent Application No. 10-2009-0111150, filed on Nov. 17, 2009, all of which are incorporated herein by reference for all purposes as if fully set forth herein.

### BACKGROUND OF THE INVENTION

1. Field of the Invention

The present invention relates to a user control-based advertising system and method, and more particularly, to a user control-based advertising system and method that may provide an advertisement controllable by a user, by discriminating an advertisement display region from an advertisement control region.

2. Discussion of the Background

Internet advertising uses the Internet. Through advertising based on merits of the Internet, companies may contact a large number of consumers with small costs, and may directly analyze customers' reaction. For example, banner advertising refers to an advertising scheme of attaching a name or description of a specific website to a side of a home page and using graphical images to promote the specific website.

In the Internet advertising, it is difficult for a user to control playback or stop of an advertisement, and to easily view a currently displayed advertisement and other advertisements.

Accordingly, there is an urgent need for an advertisement providing system and method that may enable a user to easily control a displayed advertisement and to easily search for an advertisement the user desires to view.

### SUMMARY OF THE INVENTION

The present invention provides a user control-based advertising system and method that may implement a region for displaying an advertisement and a region for controlling the advertisement by discriminating the regions from each other, and thus a user may easily play back or stop the displayed advertisement.

The present invention also provides a user control-based advertising system and method that may provide at least one advertisement campaign by rolling the at least one advertisement campaign through an input of a user, and thus the user may selectively, repeatedly view a desired advertisement in a desired time.

The present invention also provides a user control-based advertising system and method that may enable a user to select an advertisement campaign displayed on an advertisement display region, and thus the user may view a desired advertisement.

An exemplary embodiment of the present invention discloses a user control-based advertising system, including: an advertisement region setup unit to provide an advertisement display region and an advertisement control interface, the advertisement display region being used to selectively display a plurality of advertisements, and the advertisement control interface being used to control an advertisement displayed on the advertisement display region; a communication unit to receive a user command through the advertisement control interface, and to perform mutual communication with the advertisement display region according to the received command; and an advertisement control unit to control the advertisement displayed on the advertisement display region according to the user command.

The user control-based advertising system may further include a campaign list extraction unit to extract a list of advertisement campaigns for display on the advertisement display region. The advertisement campaigns may include at least one advertisement having the same theme.

The campaign list extraction unit may include an advertisement type classification unit to classify a plurality of advertisers according to advertisement types, an advertisement selection unit to receive a selection of at least one advertisement based on the advertisement types, and a list constitution unit to constitute the list of the advertisement campaigns based on the selected advertisement.

The advertisement control unit may include an advertisement rolling control unit to roll an advertisement campaign displayed on the advertisement display region according to the user command. The advertisement rolling control unit may include a rolling command receiver to receive an advertisement rolling command from the user, a campaign selector to receive a selection of a target campaign to be rolled from the list, in response to the advertisement rolling command, and an advertisement display controller to control at least one advertisement included in the selected campaign to be displayed on the advertisement display region.

The user control-based advertising system may further include a billing management unit to manage a charge for the advertisement. The billing management unit may charge for an initial advertisement displayed on the advertisement display region, and may not charge for an advertisement displayed based on the advertisement rolling command.

The user control-based advertising system may further include a billing management unit to manage a charge for the advertisement. The billing management unit may charge for each of an initial advertisement displayed on the advertisement display region, and an advertisement displayed based on the advertisement rolling command, by applying different weights to each of the advertisements.

The advertisement control unit may include an advertisement search unit to search for an advertisement to be displayed on the advertisement display region. The advertisement search unit may include a query input unit to receive an input of a query from the user through a search window in the advertisement control region, a search result providing unit to provide the user with at least one search advertisement corresponding to the query, and an advertisement display controller to receive a selection of one of the at least one search advertisement from the user, and to control the selected advertisement to be displayed on the advertisement display region.

Another exemplary embodiment of the present invention discloses a user control-based advertising method, including: discriminating an advertisement display region and an advertisement control region, the advertisement display region being used to selectively display a plurality of advertisements, and the advertisement control region being used to control an advertisement displayed on the advertisement display region; and receiving a user command through the advertisement control region, performing mutual communication with the advertisement display region according to the received command, and controlling the displayed advertisement. The controlling of the displayed advertisement may control an animation function of the advertisement displayed on the advertisement display region, or may control other advertisements displayed on the advertisement display region to be moved and selected, according to the user command.

The controlling of the displayed advertisement may include receiving the user command through the advertisement control region, and controlling at least one of playback, stop, and storage of the advertisement displayed on the advertisement display region according to the received command.

According to embodiments of the present invention, a region for displaying an advertisement and a region for controlling the advertisement may be implemented by discriminating the regions from each other, and thus a user may easily play back or stop the displayed advertisement.

Additionally, according to embodiments of the present invention, at least one advertisement campaign may be provided by rolling the at least one advertisement campaign through an input of a user, and thus the user may selectively, repeatedly view a desired advertisement in a desired time.

Furthermore, according to embodiments of the present invention, it is possible to enable a user to select an advertisement campaign displayed on an advertisement display region, and thus the user may view a desired advertisement.

### BRIEF DESCRIPTION OF THE DRAWINGS

FIG. 1 is a block diagram illustrating a user control-based advertising system according to an embodiment of the present invention.

FIG. 2 is a diagram illustrating an example of an advertisement control unit of FIG. 1.

FIG. 3 is a diagram illustrating an example of a user control rolling advertisement according to an embodiment of the present invention.

FIG. 4 is diagram illustrating an example of providing a rolling advertisement in response to a campaign list according to an embodiment of the present invention.

FIG. 5 is a diagram illustrating an example of registering a target campaign to be rolled, according to an embodiment of the present invention.

FIG. 6 is a flowchart illustrating a user control-based advertising method according to an embodiment of the present invention.

FIG. 7 is a flowchart illustrating an advertisement campaign list extracting operation of FIG. 6.

FIG. 8 is a flowchart illustrating an advertisement controlling operation of FIG. 6.

FIG. 9 is a flowchart illustrating the advertisement controlling operation of FIG. 6 according to another embodiment.

FIG. 10 is a diagram illustrating an example of an advertisement information providing page (AD cast home) provided through a portal site ‘Naver’.

FIG. 11 is a diagram illustrating a screen used to provide detailed information regarding an individual advertisement.

FIG. 12 is a flowchart of all services associated with providing of advertisement information.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

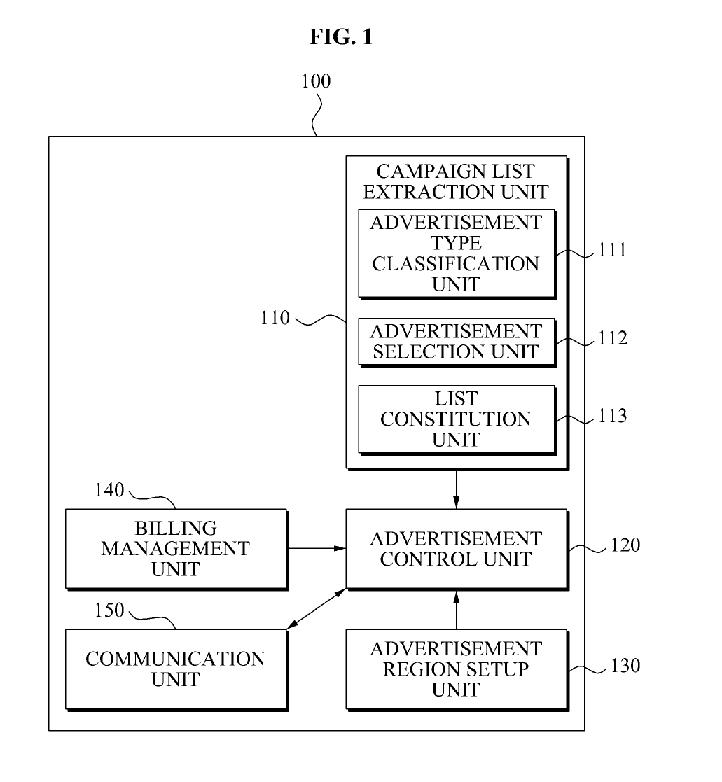

FIG. 1 is a block diagram illustrating a user control-based advertising system according to an embodiment of the present invention.

Referring to FIG. 1, a user control-based advertising system 100 may include an advertisement control unit 120, an advertisement region setup unit 130, and a communication unit 150. Additionally, the user control-based advertising system 100 may further include a campaign list extraction unit 110, and a billing management unit 140.

The advertisement region setup unit 130 may set up an advertisement display region for selectively displaying a plurality of advertisements, and an advertisement control region for controlling advertisements displayed on the advertisement display region, by discriminating the advertisement display region and the advertisement control region from each other. For example, the advertisement region setup unit 130 may discriminate an advertisement display region for displaying a banner advertisement and the like, from an advertisement control region for controlling an advertisement displayed on the advertisement display region, and may set up a region for advertisement display. Here, at least one advertisement in at least one campaign may be sequentially or randomly displayed on the advertisement display region.

According to another embodiment, the advertisement region setup unit 130 may provide an advertisement display region for selectively displaying a plurality of advertisements, and an advertisement control interface for controlling advertisements displayed on the advertisement display region. For example, the advertisement region setup unit 130 may provide a user with a web page in which the advertisement display region and the advertisement control interface are set. Here, the advertisement control interface may refer to an interface via which a user controls an advertisement displayed on the advertisement display region. For example, the advertisement control interface may be an interface that is set in the above-described advertisement control region, and that is used to detect an event such as a click event triggered by a user.

The communication unit 150 may receive a user command through the advertisement control region, and may perform mutual communication with the advertisement display region according to the received command. In other words, the communication unit 150 may receive the user command through the advertisement control region separated from the advertisement display region, and may transfer, to the advertisement display region, a command to control an advertisement displayed on the advertisement display region.

In the above-described other embodiment, the communication unit 150 may receive a user command via the advertisement control interface.

The advertisement control unit 120 may control an animation function of an advertisement displayed on the advertisement display region, or control other advertisements displayed on the advertisement display region to be moved and selected, according to the user command. Here, a user may easily play back, stop, store, and roll the advertisement displayed on the advertisement display region by clicking on a mouse button and the like. Additionally, the animation function of the advertisement may refer to a function of moving the advertisement on the advertisement display region, rather than the advertisement standing still. An advertisement having the animation function may be played back one time after the advertisement is displayed, and a still cut may be displayed when the playback of the advertisement is completed. Additionally, when the advertisement having the animation function is clicked on, movement to an advertiser site may be enabled.

According to another embodiment, the advertisement control unit 120 may control an advertisement displayed on the advertisement display region according to the user command. Here, the advertisement control unit 120 may include an advertisement playback control unit (not illustrated) to control a selection of an advertisement displayed on the advertisement display region or to control an animation function of the displayed advertisement, according to the user command received through the advertisement control interface. The animation function may include a function for at least one of playback, stop, storage, enlargement, and reduction of an advertisement displayed on the advertisement display region. To control the selection of the displayed advertisement, the advertisement control unit 120 may control a selected advertisement to be displayed, or may divide the advertisement display region into a plurality of regions and control a plurality of selected advertisements to be simultaneously displayed according to the user command.

When a static advertisement is displayed on the advertisement display region, a playback/stop button of the advertisement control region may be deactivated.

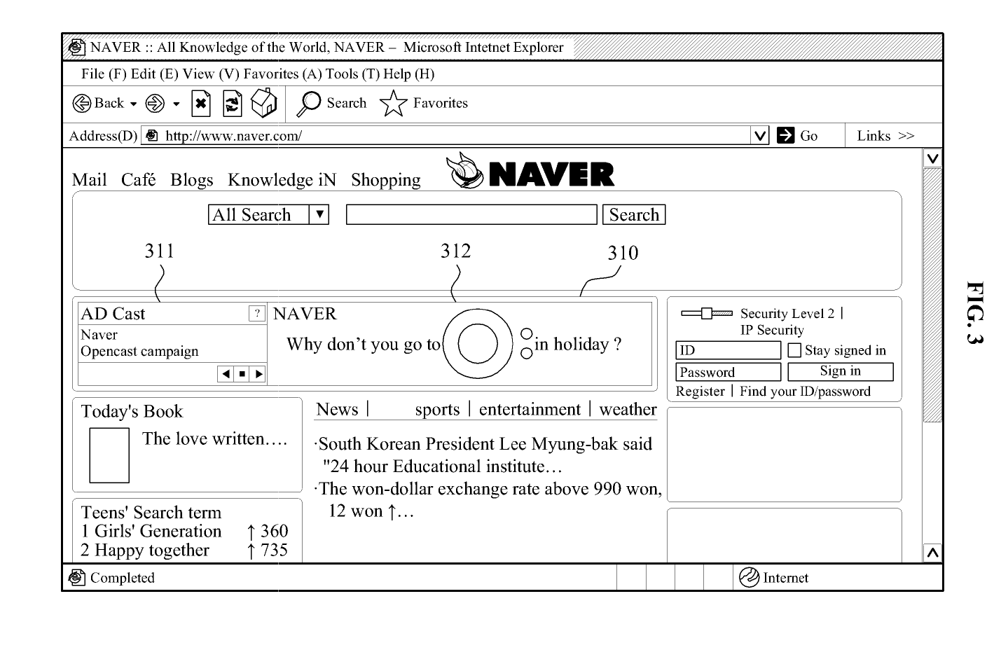

Hereinafter, the embodiment in which the advertisement display region and the advertisement control region are discriminated and provided will be described in more detail with reference to FIG. 3.

FIG. 3 is a diagram illustrating an example of a user control rolling advertisement according to an embodiment of the present invention.

Referring to FIG. 3, a region 310 for providing an advertisement of an advertiser may include an advertisement display region 312 on which an actual advertisement is displayed, and an advertisement control region 311 used to control the displayed advertisement, and accordingly, a user may easily control the displayed advertisement. For example, playback, stop, and the like of the advertisement may be controlled using a button included in the advertisement control region, and an advertisement displayed on the advertisement display region may be rolled using a rolling button. Additionally, it is possible to control a function of viewing a list of all advertisements executed for a week, a function of enlarging and capturing advertisement images, a function of clipping to a blog or a café, and the like. Furthermore, although not illustrated, various functions of controlling advertisements may be added.

Referring back to FIG. 1, the campaign list extraction unit 110 may extract a campaign list including at least one campaign. In other words, a campaign list including a target campaign to be rolled for rolling of an advertisement displayed on the advertisement display region may be extracted. Here, the campaign list may be extracted based on advertisement targeting information including at least one of gender, area and age of a user, and an advertisement display time slot.

Additionally, the extracting of the campaign list may extract a target campaign to be rolled, based on at least one of an advertisement and an advertisement type selected by a user. For example, the system may enable advertisers to be classified according to advertisement types, and enable a user to select an advertisement or campaign that is to be rolled for each advertisement type. Accordingly, the campaign list extraction unit 110 may include an advertisement type classification unit 111, an advertisement selection unit 112, and a list constitution unit 113.

The advertisement type classification unit 111 may classify a plurality of advertisers according to advertisement types.

The advertisement selection unit 112 may receive selection of at least one advertisement from a user, based on the advertisement types.

The list constitution unit 113 may constitute a list of advertisement campaigns based on the selected advertisement.

In still another embodiment, a user may select at least one advertisement or campaign from the entire advertisement pool, and may set the selected advertisement or campaign to be rolled. Accordingly, the campaign list extraction unit 110 may include an advertisement selection unit (not illustrated), and a list constitution unit (not illustrated). The advertisement selection unit (not illustrated) may receive a selection of at least one advertisement from an advertisement pool through user selection, and the list constitution unit (not illustrated) may constitute a list of advertisement campaigns based on the selected advertisement.

As described above, a user may actively select an advertisement the user desires to read, and accordingly a more customized advertisement may be displayed.

The billing management unit 140 may manage a charge for the advertisement. For example, the billing management unit 140 may calculate a number of displays, a number of clicks, an interaction, and the like that are associated with the advertisement, may write an advertising execution report, and may manage a charge and the like through the advertising execution report. However, at least one of advertisement display, advertisement click, and interaction based on the advertisement rolling may be excluded from the advertising execution report, and may not be charged. For example, only charging for an initial advertisement displayed by a system of the advertisement display region may be performed, and charging for an advertisement displayed by the user based on the advertisement rolling command may not be performed.

In another embodiment, the billing management unit 140 may charge for each of an initial advertisement displayed on the advertisement display region, and an advertisement displayed based on the advertisement rolling command. In other words, charging for the advertisement by the rolling may be equally performed based on the total number of displays.

In still another embodiment, the billing management unit 140 may charge for each of an initial advertisement displayed on the advertisement display region, and an advertisement displayed based on the advertisement rolling command, by applying different weights to the advertisements. In other words, different weights may be applied to an advertisement selected and displayed by the system, and an advertisement displayed by the user selection, and charging for each of the advertisements may be performed. For example, a first weight may be applied to the advertisement displayed by the system, and charging for the advertisement may be performed. Additionally, a second weight may be applied to the advertisement selected and displayed by rolling of the user, and charging for the advertisement may be performed.

The charging for display of advertisements has been described above. In addition, charging may be performed for an action to which a charge is applicable, for example clicking on an advertisement, according to the embodiments.

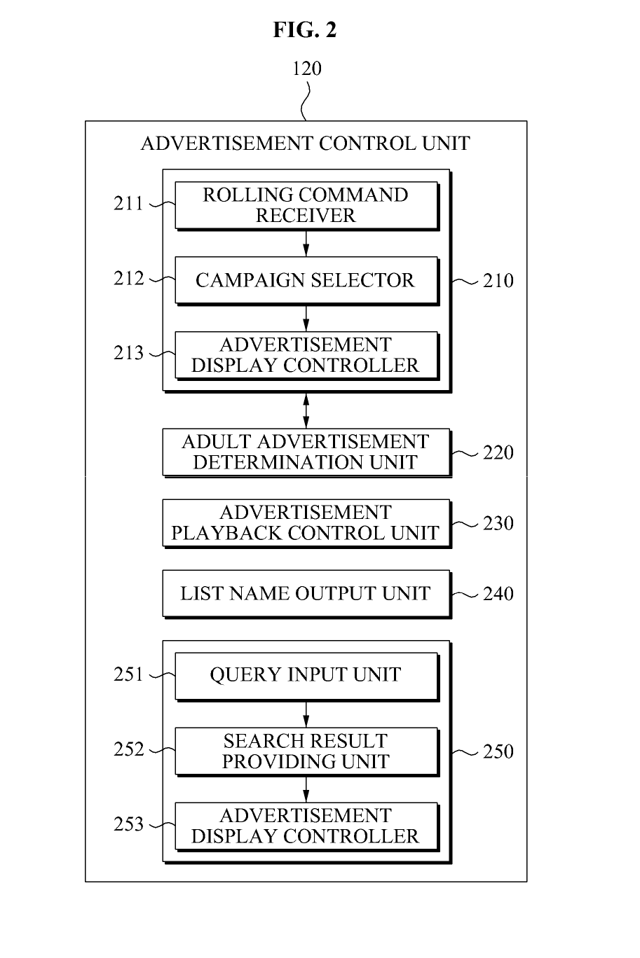

FIG. 2 is a diagram illustrating an example of the advertisement control unit 120 of FIG. 1.

Referring to FIG. 2, the advertisement control unit 120 may include an advertisement rolling control unit 210, an adult advertisement determination unit 220, an advertisement playback control unit 230, a list name output unit 240, and an advertisement search unit 250.

The advertisement rolling control unit 210 may roll an advertisement campaign displayed on the advertisement display region according to the user command. For example, when a user clicks on an advertisement rolling button to roll an advertisement displayed on the advertisement display region, the advertisement may be rolled and displayed on the advertisement display region. Here, the advertisement rolling may be performed for each campaign. For example, when an advertisement included in campaign A is currently displayed on the advertisement display region, and when a user instructs advertisement rolling by clicking on the advertisement rolling button, rolling from campaign A to campaign B may be performed, and an advertisement included in campaign B may be displayed on the advertisement display region. Here, one of campaigns in the campaign list may be sequentially rolled. To perform advertisement rolling, the advertisement rolling control unit 210 may include a rolling command receiver 211, a campaign selector 212, and an advertisement display controller 213.

The rolling command receiver 211 may receive an advertisement rolling command from the user. The campaign selector 212 may receive a selection of a target campaign to be rolled from the advertisement campaign list, in response to the advertisement rolling command. The advertisement display controller 213 may control at least one advertisement included in the selected campaign to be displayed on the advertisement display region.

The adult advertisement determination unit 220 may determine whether the rolled advertisement campaign includes an adult advertisement. Whether to display a campaign including the adult advertisement may be determined based on whether the user is an adult. Specifically, when the adult advertisement is not included in the rolled campaign, the rolled campaign may be displayed regardless of whether the user is an adult. Conversely, when the adult advertisement is included in the rolled campaign, and only when the user is an adult, the rolled campaign may be displayed.

The advertisement playback control unit 230 may control at least one of playback, stop, and storage of an advertisement displayed on the advertisement display region, according to the user command received through the advertisement control region. Specifically, when a user desires to play back or stop a displayed advertisement, the advertisement may be enabled to be played back or stopped using a separate playback/stop button, and the like. Additionally, when a user desires to clip a displayed advertisement, the displayed advertisement may be enabled to be stored through a separate storage button. Here, when the advertisement is being loaded in the advertisement display region, a user command for at least one of playback, stop, and storage of the advertisement may not be received. In other words, the user command may not be received by deactivating a playback button included in the advertisement control region, to prevent an error from occurring due to a user's action while the advertisement is loaded in the advertisement display region.

When the advertisement is not loaded in the advertisement display region, the advertisement playback control unit 230 may display an image substituted for the advertisement, and may not receive a user command for at least one of playback, stop, and storage of the advertisement. For example, when loading of an advertisement is delayed or the advertisement is not loaded due to a PC environment and network status of a user, an image substituted for the advertisement may be displayed, and a user command may not be received by deactivating a playback button included in the advertisement control region. In other words, an action corresponding to a mouse-over or click may be prevented by deactivation of a button.

The list name output unit 240 may output, to the advertisement control region, at least one of a brand name and campaign description of an advertisement displayed on the advertisement display region. Specifically, at least one of a brand name and campaign description of a currently displayed advertisement may be enabled to be output in the advertisement control region for controlling the advertisement, separately from an advertisement display region on which the advertisement is displayed. Accordingly, separately from the advertisement display region, the brand name, the campaign description, and the like of the advertisement may be displayed, and thus it is possible to further increase an advertising effect.

The advertisement search unit 250 may search for an advertisement to be displayed on the advertisement display region. Here, the advertisement search unit 250 may include a query input unit 251, a search result providing unit 252, and an advertisement display controller 253.

The query input unit 251 may receive an input of a query from the user through a search window within the advertisement control region. The search result providing unit 252 may provide the user with at least one search advertisement corresponding to the query. The advertisement display controller 253 may receive a selection of one of the at least one search advertisement from the user, and may control the selected advertisement to be displayed on the advertisement display region.

For example, when a user, desiring to read a specific advertisement, enters a query used to search for the specific advertisement, in the search window within the advertisement control region, a search result list corresponding to the query may be enabled to be displayed. When the user selects the specific advertisement from the displayed search result list, the selected advertisement may be displayed on the advertisement display region, and thus the user may easily read the advertisement by searching for the advertisement.

As described above, it is possible to perform playback, storage, rolling, and the like with respect to an advertisement, using an advertisement display region for displaying advertisements, and using an advertisement control region for controlling advertisements that is discriminated from the advertisement display region. Thus, a user may actively select and configure an advertisement, and an advertisement desired by the user may be targeted.

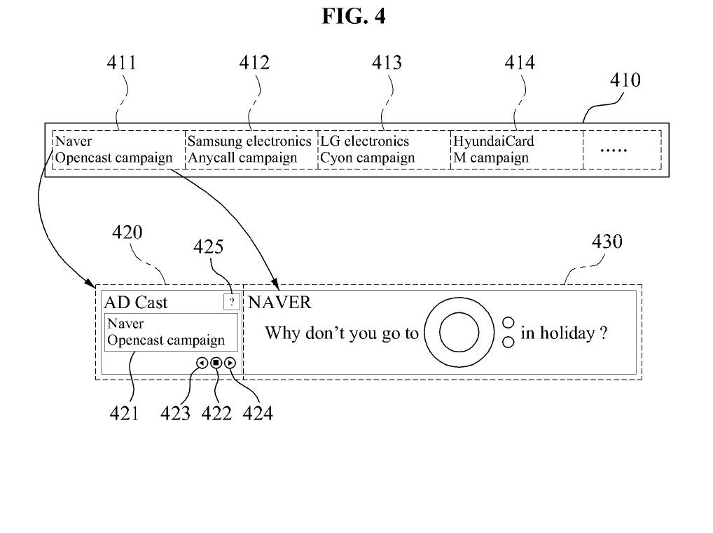

FIG. 4 is a diagram illustrating an example of providing a rolling advertisement in response to a campaign list according to an embodiment of the present invention.

Referring to FIG. 4, advertisements may be provided for each campaign, and a single campaign may include a plurality of advertisements. Here, advertisement campaigns to be displayed on an advertisement display region 430 may be selected by a user, or may be randomly selected from an advertisement pool, and the selected advertisement campaigns may be configured in the form of a campaign list 410.

For example, to select campaigns to constitute a campaign list, a user may select at least one of advertisement types that are categorized in advance. Additionally, the user may select at least one of advertisements or campaigns in an advertisement pool, and may constitute a campaign list. In an example, when user A selects, as advertisement campaigns that the user A desires to display, a ‘Naver's opencast campaign 411’, a ‘Samsung electronics' Anycall campaign 412’, an ‘LG electronics' Cyon campaign 413’, a ‘HyundaiCard's M campaign 414’, and the like, at least one selected campaign may be sequentially displayed on the advertisement display region. Here, while an advertisement included in the ‘Naver's opencast campaign’ is displayed on the advertisement display region 430, when the user clicks on a next campaign rolling button 424, an advertisement included in the ‘Samsung electronics' Anycall campaign’ may be displayed. Accordingly, the user may be enabled to directly select an advertisement the user desires to display and thus, it is possible to display a targeted advertisement, and to increase a user's interest in the advertisement.

A region where advertisements are provided may be divided into the advertisement display region 430 and an advertisement control region 420. The advertisement display region 430 may be used to actually display banner advertisements, and the like, and the advertisement control region 420 may be used to control advertisements displayed on the advertisement display region. Here, the advertisement control region 420 may include a list name output unit 421 to output at least one of a brand name and campaign description of an advertisement. As illustrated in FIG. 4, ‘Naver’ that is a brand name of an advertisement currently displayed on the advertisement display region 430, and ‘opencast campaign’ that is a campaign description of the advertisement may be output by the list name output unit 421. Additionally, the advertisement control region 420 may provide a playback button 422 used to control playback/stop of an advertisement displayed on the advertisement display region 430, the next campaign rolling button 424 used to perform rolling to a next campaign of a currently displayed campaign, a previous campaign rolling button 423 used to perform rolling to a previous campaign of the currently displayed campaign, and a help button 425 used to provide help.

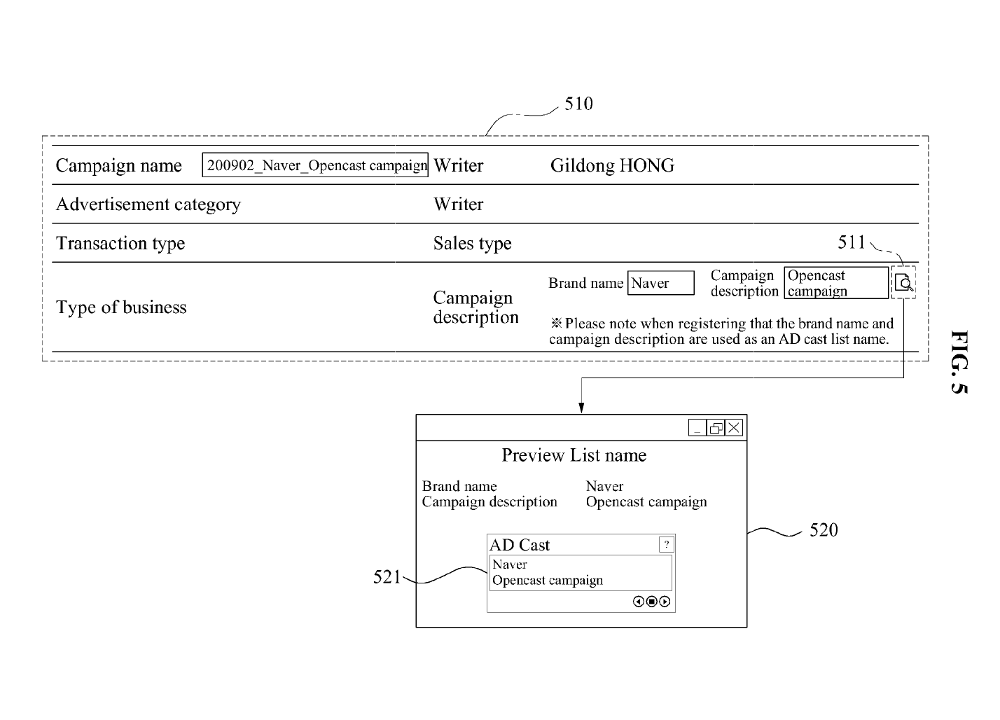

FIG. 5 is a diagram illustrating an example of registering a target campaign to be rolled, according to an embodiment of the present invention.

Referring to FIG. 5, an advertiser may enter a campaign description, an advertisement category, an advertisement type, a brand name, a campaign description, and the like, and may register a campaign for a user control-based rolling advertisement. Here, a user may look at a screen 510 of an advertisement control region, on which a list name including at least one of the brand name and the campaign description is displayed, through a ‘preview’ function. In other words, when the user clicks on a preview icon 511, a screen displayed on an advertisement control region 521 may be previewed in a preview window 520.

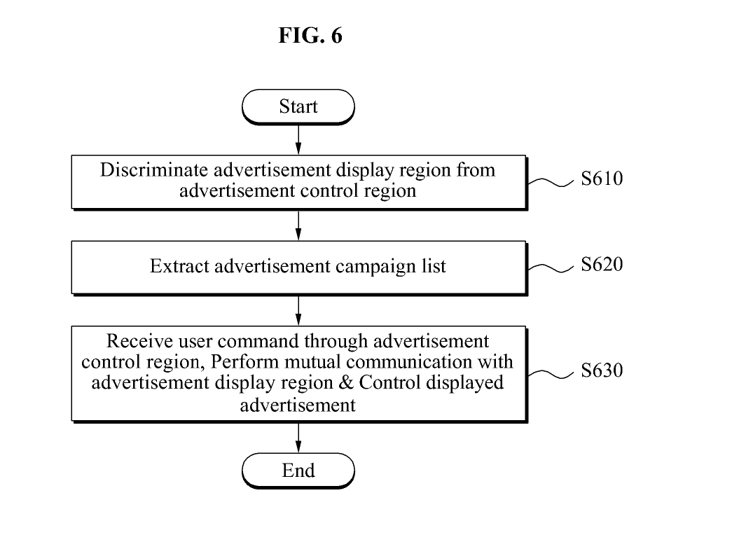

FIG. 6 is a flowchart illustrating a user control-based advertising method according to an embodiment of the present invention.

Referring to FIG. 6, in operation S610, an advertisement display region for selectively displaying a plurality of advertisements, and an advertisement control region for controlling advertisements displayed on the advertisement display region may be discriminated. In other words, the advertisement display region for displaying an advertisement, and the advertisement control region for controlling the advertisement displayed on the advertisement display region may be discriminated from each other, and may communicate with each other, and thus it is possible to easily control advertisements.

According to another embodiment, in the operation S610, an advertisement display region for selectively displaying a plurality of advertisements, and an advertisement control interface for controlling advertisements displayed on the advertisement display region may be provided. For example, a web page in which the advertisement display region and the advertisement control interface are set may be provided to a user. Here, the advertisement control interface may refer to an interface via which a user controls an advertisement displayed on the advertisement display region. For example, the advertisement control interface may be an interface that is set in the above-described advertisement control region, and that is used to detect an event such as a click event triggered by a user.

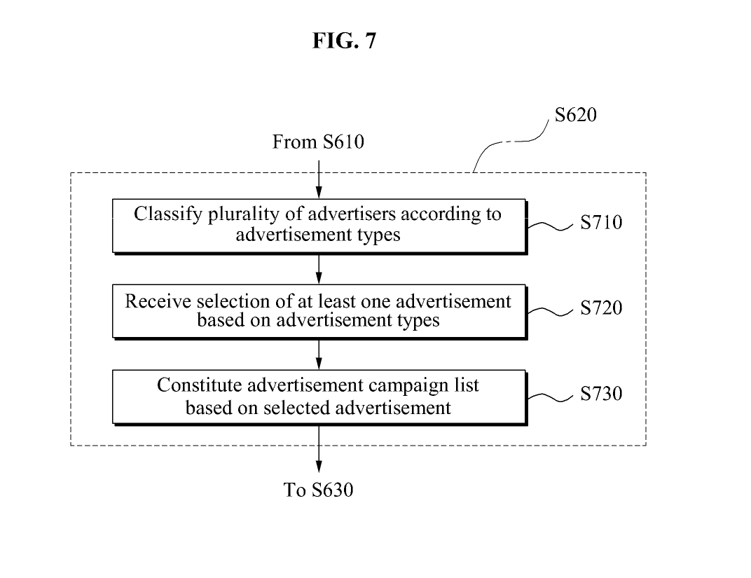

In operation S620, an advertisement campaign list may be extracted to be displayed on the advertisement display region. Here, the advertisement campaign list may be extracted by a system or a user. When the advertisement campaign list is automatically extracted by the system, at least one advertisement campaign may be extracted based on advertisement targeting information including at least one of gender, area and age of a user, and an advertisement display time slot. Hereinafter, an operation of extracting the advertisement campaign list by the user will be further described with reference to FIG. 7.

FIG. 7 is a flowchart illustrating an operation of extracting an advertisement campaign list as illustrated in FIG. 6.

Referring to FIG. 7, in operation S710, a plurality of advertisers may be classified according to advertisement types. In operation S720, a selection of at least one advertisement may be received from the user based on the advertisement types. Additionally, in operation S730, an advertisement campaign list may be constituted based on the selected advertisement.

As another example of extracting a campaign list based on a user's selection, at least one advertisement may be selected from an advertisement pool, and an advertisement campaign list may be constituted based on the selected advertisement.

Referring back to FIG. 6, in operation S630, a user command may be received through the advertisement control region, mutual communication with the advertisement display region may be performed according to the received command, and the displayed advertisement may be controlled. Here, controlling of the displayed advertisement may be performed by controlling an animation function of an advertisement displayed on the advertisement display region based on the user command, or by controlling other advertisements displayed in the same period to be moved and selected. For example, a user may control playback and stop of an advertisement displayed on the advertisement display region by clicking on a button and the like included in the advertisement control region, and may control an advertisement campaign displayed in the same period to be selected by rolling through a button click, and the like.

In the above-described other embodiment, in operation S630, the user command may be received through the advertisement control interface. As described above, the advertisement control interface may refer to an interface via which a user controls an advertisement displayed on the advertisement display region. Additionally, according to still another embodiment, in operation S630, an advertisement displayed on the advertisement display region may be controlled according to the user command. Here, operation S630 may include an operation (not illustrated) of receiving the user command through the advertisement control interface, and an operation (not illustrated) of controlling a selection of an advertisement displayed on the advertisement display region or an animation function of the displayed advertisement according to the received command. The animation function may include a function for at least one of playback, stop, storage, enlargement, and reduction of the advertisement displayed on the advertisement display region.

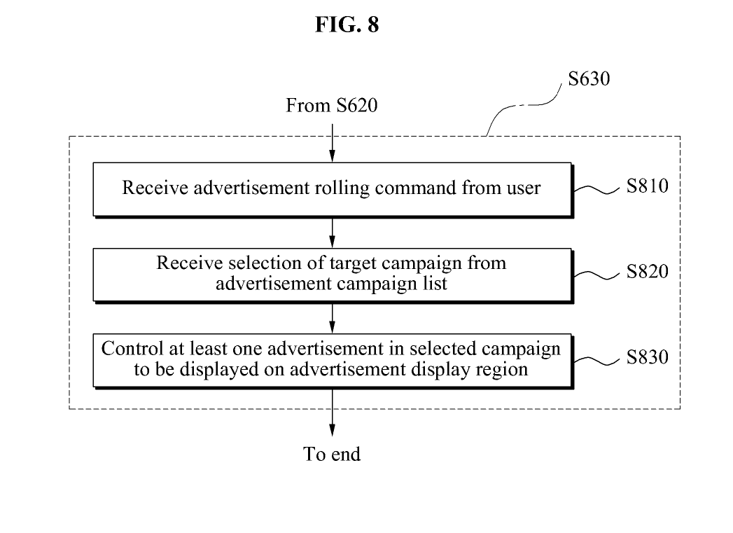

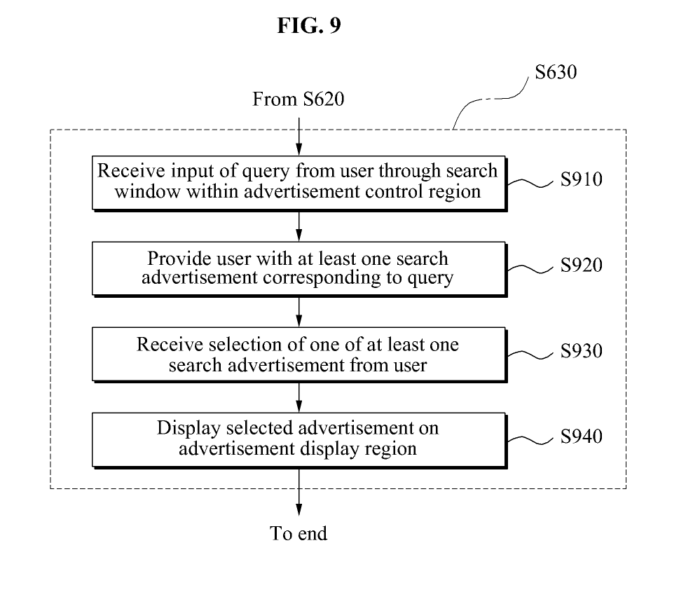

Hereinafter, an advertisement controlling operation will be described in more detail with reference to FIGS. 8 and 9.

FIG. 8 is a flowchart illustrating an advertisement rolling operation in the advertisement controlling operation illustrated in FIG. 6.

Referring to FIG. 8, in operation S810, an advertisement rolling command may be received from the user. For example, the advertisement rolling command may be received from the user through a button click, and the like. In operation S820, a selection of a target campaign from a advertisement campaign list may be received from the user.

In operation S830, at least one advertisement included in the selected campaign may be controlled to be displayed on the advertisement display region. In other words, an advertisement campaign selected by the user through the advertisement rolling may include at least one advertisement, and one of the at least one advertisement included in the advertisement campaign may be displayed on the advertisement display region.

FIG. 9 illustrates an advertisement search operation in the advertisement controlling operation illustrated in FIG. 6.

Referring to FIG. 9, in operation S910, an input of a query may be received from the user through a search window within the advertisement control region. Here, when a user desires to search for a specific advertisement, he or she may enter a search keyword in the search window.

In operation S920, at least one search advertisement corresponding to the query may be provided to the user. In other words, a search result corresponding to the query of the user may be provided to the user.

In operation S930, a selection of one of the at least one search advertisement may be received from the user. In other words, the user may select a desired advertisement from the search result.

In operation S940, the selected advertisement may be controlled to be displayed on the advertisement display region. In other words, the advertisement selected by the user may be displayed on the advertisement display region.

Unexplained parts in FIGS. 6 through 9 may be understood based on descriptions of FIGS. 1 through 5.

Additionally, the advertisement control region 311 of FIG. 3 may include a link to a web page that provides additional information regarding a plurality of advertisements that may be provided to a user. For example, advertisement information providing page provided by the Internet portal site ‘Naver’ (www.naver.com) may be called ‘AD cast home’. Here, an AD cast service provided in the AD cast home may provide a function enabling a user to conveniently search for various advertisements that are available online and offline. The AD cast service may enable a corresponding advertisement to be displayed when a corresponding company agrees to provide the advertisement. In other words, when an advertiser disagrees with advertisement display, or when a period during which the advertisement display is agreed elapses, a corresponding advertisement may not be searched for or displayed. The AD cast service may provide a player to provide moving image advertising or voice advertising such as a CF, and may restrict display of an advertisement such as alcoholic beverages or cigarettes through an adult authentication using a login service and the like.

An advertisement may be searched for from the AD cast home through the following methods: First, when a desired advertisement is clicked on by accessing the AD cast home in which currently running advertisements are randomly arranged, details regarding the advertisement may be examined. Second, when an industry type tab is selected, a currently running advertisement, or advertisements that were in progress in the past may be shown. Third, advertisements may be examined by directly searching for a related keyword such as a product name or a brand name in the AD cast service.

A template of a selected advertisement may include a variety of information, such as an advertising execution period, a production company, a model, and an advertising concept, in addition to materials used in advertising (for example, moving images, flashes, and the like). The variety of information may be viewed by a user only when a corresponding company provides the information, and accordingly viewed information may be determined based on advertisements.

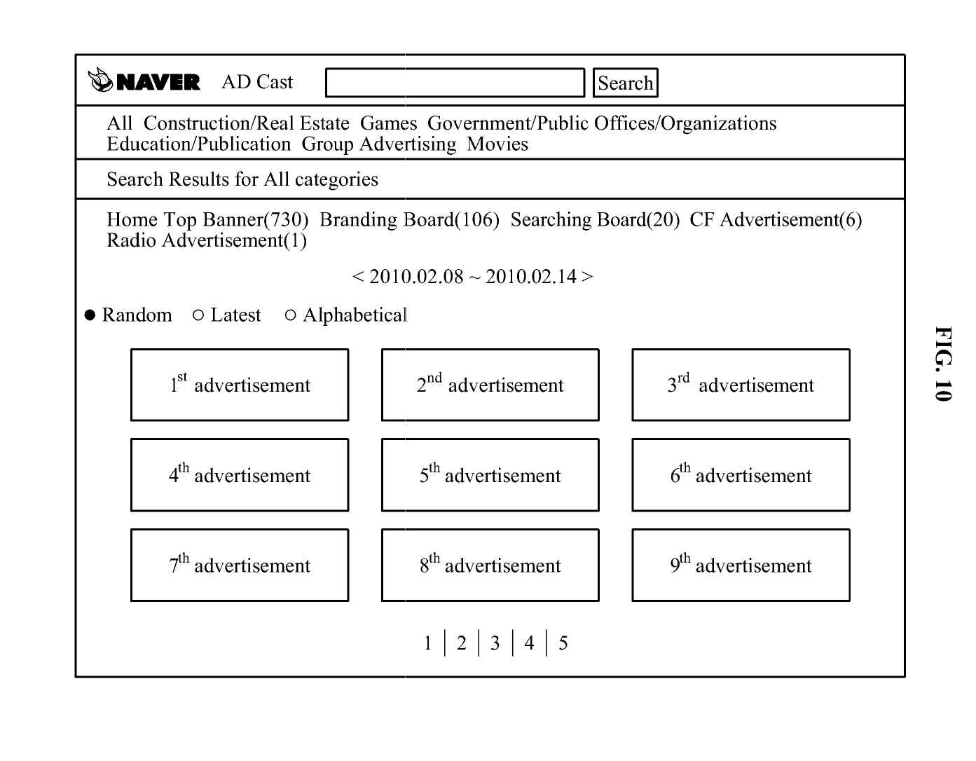

FIG. 10 illustrates an example of an advertisement information providing page (AD cast home) provided through a portal site ‘Naver’. The above-described advertisement information providing page may be provided by collecting banner advertisements that are displayable on the advertisement display region 310. A user may read information on multiple advertisements from the advertisement information providing page. Here, in the example of FIG. 10, browsing may be performed for each advertisement type, for each advertisement period, and for each advertisement product (for each advertisement display inventory type). Additionally, a user may select a specific advertiser and/or brand, and may collect and read advertisements associated with a corresponding advertiser/brand.

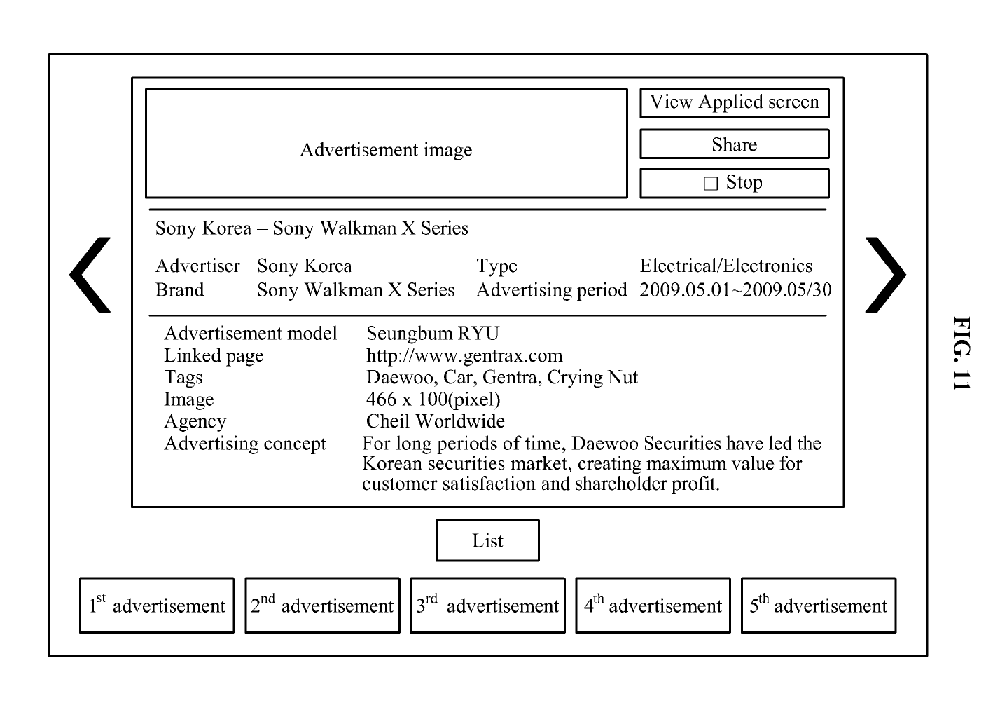

FIG. 11 illustrates a screen used to provide detailed information regarding an individual advertisement. Such an advertisement detailed information providing page may be provided to a user when a thumbnail or title of the advertisement of FIG. 10 is clicked on. In the advertisement detailed information providing page, pieces of additional information regarding individual advertisements (for example, an advertisement model, an advertisement agency, and the like) may be provided. Additionally, a link to a service page to which a corresponding advertisement is applied may also be provided. In the case of moving image advertising and voice advertising, a user may click on a playback button of a player included in the advertisement detailed information providing page, so that a corresponding moving image advertisement and a corresponding voice advertisement may be played back. Furthermore, the user may be provided with a means for moving a corresponding advertisement to another Internet bulletin space. The means may enable the user to be provided with a code for posting the creative regarding the corresponding advertisement on a blog of the user.

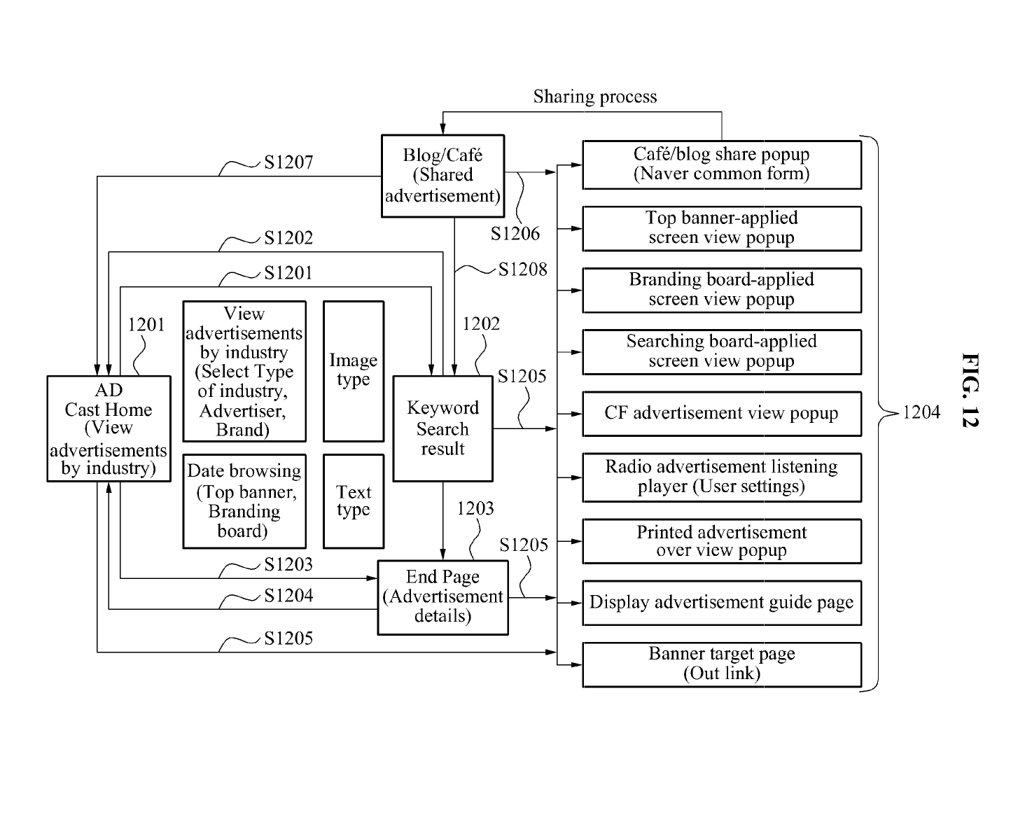

FIG. 12 is a flowchart of all services associated with providing of advertisement information. First, FIG. 12 illustrates movement between an AD cast home 1201, a keyword search result 1202, and an ‘End Page’ 1203 that is an advertisement detailed information providing page. Specifically, when a keyword is input or a recommended search term is clicked on in the AD cast home 1201 (S1201), the keyword search result 1202 may be provided to a user. When a type of industry is selected or an ‘AD cast’ is clicked on in the keyword search result 1202 (S1202), the AD cast home 1201 may be provided to a user. Additionally, when a thumbnail or title in an inquiry result is clicked on in the AD cast home 1201 (S1203), the ‘End Page’ 1203, namely a corresponding advertisement detailed information providing page, may be provided to a user. Furthermore, when type of industry is selected or an ‘AD cast’ is clicked on in the ‘End Page’ 1203 (S1204), the AD cast home 1201 may be provided to a user. In addition, each item in detailed information is clicked on in the AD cast home 1201, the keyword search result 1202, and the ‘End Page’ 1203 (S1205), each corresponding process 1204 may be performed as illustrated in the right of FIG. 12. Moreover, a corresponding advertisement may be shared through a café/blog share popup. When each item in detailed information is clicked on in a blog or café (S1206), each corresponding process 1204 may also be performed. Additionally, when the ‘AD cast’ is clicked on (S1207), or a tag is clicked on (S1208) through a shared advertisement in a blog or café, the AD cast home 1201 or the keyword search result 1202 may be provided to a user.

As described above, an advertisement display region and an advertisement control region may be provided by discriminating the regions from each other, and thus it is possible for a user to more easily control an advertisement.

Additionally, rolling of an advertisement may be more actively performed by a simple button manipulation of a user and the like, and thus the user may selectively read a desired advertisement, and an effect of targeting an advertisement may be improved.

Furthermore, it is possible for a user to select an advertisement campaign that is displayed based on a selection of the user and thus, the user may actively consume an advertisement.

The user control-based advertising method according to embodiments of the present invention may be recorded in computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An advertising system, comprising:
an advertisement region setup unit to provide an advertisement display region and an advertisement control interface, the advertisement display region to selectively display a plurality of advertisements, and the advertisement control interface to control an advertisement displayed on the advertisement display region;
a computer to receive a command via the advertisement control interface, and to communicate with the advertisement display region according to the received command; and
an advertisement control unit to control the advertisement displayed on the advertisement display region according to the command.

2-7. (canceled)

8. The advertising system of claim 1, further comprising:
a billing management unit to manage a charge for the advertisement,
wherein the billing management unit charges for a first advertisement displayed on the advertisement display region, and does not charge for an advertisement displayed based on the command.

9. The advertising system of claim 1, further comprising:
a billing management unit to manage a charge for the advertisement,
wherein the billing management unit charges for a first advertisement displayed on the advertisement display region, and a second advertisement displayed based on the command.

10. The advertising system of claim 1, further comprising:
a billing management unit to manage a charge for the advertisement,
wherein the billing management unit charges for a first advertisement displayed on the advertisement display region, and a second advertisement displayed based on the command, by applying different weights to each of the advertisements.

11. The advertising system of claim 1, wherein the advertisement control unit comprises an advertisement playback control unit to control a selection of the advertisement displayed on the advertisement display region or an animation function of the displayed advertisement according to the command received via the advertisement control interface.

12. The advertising system of claim 11, wherein the animation function comprises a function for at least one of playback, stop, storage, enlargement, and reduction of the advertisement displayed on the advertisement display region.

13. The advertising system of claim 11, wherein, in response to advertisement not being loaded in the advertisement display region, the advertisement playback control unit displays an image substituted for the advertisement, and does not receive a command for at least one of playback, stop, and storage of the advertisement.

14. The advertising system of claim 1, wherein the advertisement control interface is set in a displayed advertisement control region, and
wherein the advertisement control unit comprises a list name output unit to output, to the displayed advertisement control region, at least one of a brand name and a campaign description of the advertisement displayed on the advertisement display region.

15. The advertising system of claim 1, wherein the advertisement control interface is set in a displayed advertisement control region,
wherein the advertisement control unit comprises an advertisement search unit to search for an advertisement to be displayed on the advertisement display region, and
wherein the advertisement search unit comprises:
a query input unit to receive a query via a search window in the advertisement control region;
a search result providing unit to provide at least one search advertisement corresponding to the query; and
an advertisement display controller to receive a selection of one of the at least one search advertisement from the user, and to control the selected advertisement to be displayed on the advertisement display region.

16. An advertising method performed by a computer, the method comprising:
providing an advertisement display region and an advertisement control interface, the advertisement display region to selectively display a plurality of advertisements, and the advertisement control interface to control an advertisement displayed on the advertisement display region;
receiving a command via the advertisement control interface; and
communicating with the advertisement display region according to the received command, and controlling the displayed advertisement.

17-22. (canceled)

23. The advertising method of claim 16, further comprising:
managing a charge for the advertisement,
wherein the managing comprises:
charging for a first advertisement displayed on the advertisement display region; and
not charging for an advertisement displayed based on the command.

24. The advertising method of claim 16, further comprising:
managing a charge for the advertisement,
wherein the managing comprises:
charging for a first advertisement displayed on the advertisement display region; and
charging for a second advertisement displayed based on the command.

25. The advertising method of claim 16, further comprising:
managing a charge for the advertisement,
wherein the managing comprises:
assigning a first weight to a first advertisement displayed on the advertisement display region, and charging for the first advertisement; and
assigning a second weight to a second advertisement displayed based on the command, and charging for the second advertisement.

26. The advertising method of claim 16, wherein receiving the command comprises:
receiving the command via the advertisement control interface; and
controlling a selection of the advertisement displayed on the advertisement display region or an animation function of the displayed advertisement according to the received command.

27. The advertising method of claim 26, wherein the animation function comprises a function for at least one of playback, stop, storage, enlargement, and reduction of the advertisement displayed on the advertisement display region.

28. The advertising method of claim 27, wherein controlling of the at least one of playback, stop, and storage of the advertisement comprises, in response to an advertisement not being loaded in the advertisement display region, displaying an image substituted for the advertisement, and not receiving a command for at least one of playback, stop, and storage of the advertisement.

29. The advertising method of claim 16,
wherein the advertisement control interface is set in a displayed advertisement control region, and
wherein receiving the user command comprises outputting, to the advertisement control region, at least one of a brand name and a campaign description of the advertisement displayed on the advertisement display region.

30. The advertising method of claim 16,
wherein the advertisement control interface is set in a displayed advertisement control region, and
wherein receiving the command comprises:
receiving a query via a search window in the advertisement control region;
providing at least one search advertisement corresponding to the query;
receiving a selection of one of the at least one search advertisement from the user; and
controlling the selected advertisement to be displayed on the advertisement display region.

31. A non-transitory computer readable recording medium storing a program, that when executed, causes a computer to implement the method of claim 16.
